(19) United States
(12) Patent Application Publication
(10) Pub. No.: US 2013/0037976 A1
(43) Pub. Date: Feb. 14, 2013

(54) Lens Array Production Method and Laminated Lens Array Production Method

(71) Applicants: Takaichi Hayashida, Fussa-shi (JP); Masashi Saito, Koganei-shi (JP)

(72) Inventors: Takaichi Hayashida, Fussa-shi (JP); Masashi Saito, Koganei-shi (JP)

(21) Appl. No.: 13/642,686

(22) PCT Filed: Apr. 4, 2011
(86) PCT No.: PCT/JP2011/058502

§ 371 Date: Oct. 22, 2012

(51) Int. Cl. B29D 11/00

(52) U.S. Cl. 264/1.7

(57) ABSTRACT

A method of manufacturing a lens array includes the steps of feeding a first curable resin between a first array mold and a plate member and curing the first resin; separating the plate member from the first array mold; feeding a second curable resin between the first array mold and a second array mold while leaving the cured first resin on the first array mold, and curing the second resin; and removing the first array mold and the second array mold.

### TECHNICAL FIELD

The present invention relates to a method of manufacturing a lens array and a method of manufacturing a stacked lens array.

### BACKGROUND ART

In order to reduce a manufacturing cost of imaging lenses or image capturing devices including imaging lenses, a method is known which involves production of lens arrays each consisting of multiple lenses, stacking the lens arrays one another or stacking the lens array and a sensor array consisting of multiple sensors (the number and the locations of the sensors corresponding to the number and the locations of the lens units in the lens array), and cutting (separating) the resultant stack into pieces each including a lens unit.

According to such a method, two array molds 100 and 110 with multiple recesses (or projections), respectively, corresponding to the shape of lenses are firstly prepared as shown in FIG. 5A, and the mold 100 is coated with a photocurable or thermally curable resin 120. Then, as shown in FIG. 5B, one of the array molds 100 and 110 is moved onto the other such that the space between molds 100 and 110 is filled with the curable resin 120, and the resin 120 is cured by light or heat. Then, the array molds 100 and 110 are removed as shown in FIG. 5C to yield a lens array 122 composed of the cured resin 120 (Refer to Patent Literature 1).

### CITATION LIST

### Patent Literature

Patent Literature 1: Japanese Patent Application Laid-Open Publication No. 2009-279774 (refer to, for example, paragraphs [0031], [0071]-[0072], and [0074]-[0078])

### SUMMARY OF THE INVENTION

### Technical Problem

Unfortunately, removing the array molds 100 and 110 just after the curing of the resin 120 may cause the cured resin 120 to be deformed after the molds are removed, resulting a variation in pitches of the lenses (distances between the lenses) within a single lens array 122. This may lead to misalignment between lenses when lens arrays 122 are stacked one another, or between a lens array and a sensor array when a lens array 122 and a sensor array are stacked together.

Accordingly the main object of the current invention is to provide a method of manufacturing a lens array and a method of manufacturing a stacked lens array which can suppress a variation in lens pitches.

### Solution to Problem

According to a first aspect of the present invention, there is provided a method of manufacturing a lens array, the method includes the steps of:

feeding a first curable resin between a first array mold and a plate member and curing the first resin;

separating the plate member from the first array mold;

feeding a second curable resin between the first array mold and a second array mold while leaving the cured first resin on the first array mold, and curing the second resin; and

removing the first array mold and the second array mold.

Preferably, the method further includes the step of forming diaphragms on the cured first resin remaining on the first array mold, after separating the plate member and before feeding the second curable resin and curing the second resin.

According to a second aspect of the present invention, there is provided a method of manufacturing a stacked lens array, the method includes the steps of;

feeding a first curable resin between a first array mold and a second array mold, and curing the first resin;

removing the second array mold;

feeding a second curable resin between a third array mold and a fourth array mold, and curing the second resin;

removing the fourth array mold;

bonding the cured first resin remaining on the first array mold and the cured second resin remaining on the third array mold; and

removing the first array mold and the third array mold.

Preferably, the method further includes a step of forming a diaphragm on the cured first resin remaining on the first array mold after removing the second array mold.

### Advantageous Effect of Invention

According to the first aspect of the present invention, the step of feeding and curing the second curable resin is performed while the first curable resin is left on the first array mold after curing. This can prevent a variation in lens pitches in the first curable resin at least during the step of feeding and curing of the second curable resin. Moreover the first aspect of the present invention can eliminate the use of an adhesive, and thus reduce the manufacturing cost and steps.

More importantly, the diaphragm is formed in the step between the first curable resin molding and the second curable resin molding. This means that the diaphragm is formed inside the structure of an imaging lens. Thus a separate installation step of a diaphragm on the exterior of an imaging lens is not necessary, and also misalignment between the lens and the diaphragm can be prevented. Additionally, the diaphragm is provided in the area shaped by the plate member of the resin. As a result, the diaphragm resides on a planar surface and can be formed precisely. A further advantage of this case is application of patterning techniques, such as photolithography and screen printing, which are rather inappropriate to delineate patterns on a curved surface.

According to the second aspect of the present invention, the step of bonding the cured first resin and the cured second resin is performed while the first resin is left on the first array mold after curing and the second resin is left on the third array mold after curing. This can reduce variations in distances between lens components both in the cured first resin and the cured second resin, at least during the bonding step of the cured first resin and the cured second resin.

More importantly, the diaphragm is formed before the steps of bonding between the cured first resin and the cured second resin. This means that the diaphragm is formed inside the structure of a stacked imaging lens. Thus a separate installation step of a diaphragm on the exterior of a stacked imaging lens is not necessary, and also misalignment between the lens and the diaphragm can be prevented.

### BRIEF DESCRIPTION OF DRAWINGS

FIG. 1 is a schematic cross sectional view of an imaging lens.

FIG. 2A schematically shows a method of manufacturing the imaging lens of FIG. 1.

FIG. 2B schematically shows a manufacturing step following the step of FIG. 2A.

FIG. 2C schematically shows a manufacturing step following the step of FIG. 2B.

FIG. 2D schematically shows a manufacturing step following the step of FIG. 2C.

FIG. 2E schematically shows a manufacturing step following the step of FIG. 2D.

FIG. 2F schematically shows a manufacturing step following the step of FIG. 2E.

FIG. 2G schematically shows a manufacturing step following the step of FIG. 2F.

FIG. 3 is a schematic cross sectional view of a stacked imaging lens.

FIG. 4A schematically shows a method of manufacturing the stacked imaging lens of FIG. 3.

FIG. 4B schematically shows a manufacturing step following the step of FIG. 4A.

FIG. 4C schematically shows a manufacturing step following the step of FIG. 4B.

FIG. 4D schematically shows a manufacturing step following the step of FIG. 4C.

FIG. 4E schematically shows a manufacturing step following the step of FIG. 4D.

FIG. 4F schematically shows a manufacturing step following the step of FIG. 4E.

FIG. 5A schematically shows a method of manufacturing a conventional stacked lens array.

FIG. 5B schematically shows a manufacturing step following the step of FIG. 5A.

FIG. 5C schematically shows a manufacturing step following the step of FIG. 5B.

### DESCRIPTION OF THE PREFERRED EMBODIMENTS

Embodiments of the present invention will now be described with reference to the accompanying drawings.

### First Embodiment

As shown in FIG. 1, an imaging lens 2 is an optical lens including a combination of a resin component 4 and a resin component 6.

The resin component 4 has a convex lens portion 4a. The convex lens portion 4a is surrounded by a non-lens portion 4b or flange. The resin component 6 also has a convex lens portion 6a. The convex lens portion 6a is surrounded by a non-lens portion 6bor flange.

The convex lens portion 4a of the resin component 4 and the convex lens portion 6a of the resin component 6 are aligned with each other. An optical axis runs through the centers of the convex lens portions 4a and 6a. A diaphragm 8 is provided between the non-lens portion 4b of the resin component 4 and the non-lens portion 6bof the resin component 6 in the interface of the resin components 4 and 6.

The resin component 4 is composed of a resin 4A, and the resin component 6 is composed of a resin 6A.

The resin 4A and 6A are of photocurable or thermally curable types.

The resin 4A and 6A are different materials with different optical dispersions (Abbe's numbers), and in particular a low dispersion material for the resin 4A while a high dispersion material for the resin 6A.

The resin 4A and 6A may be of the same type.

Next, a method of manufacturing the imaging lens 2 will now be described.

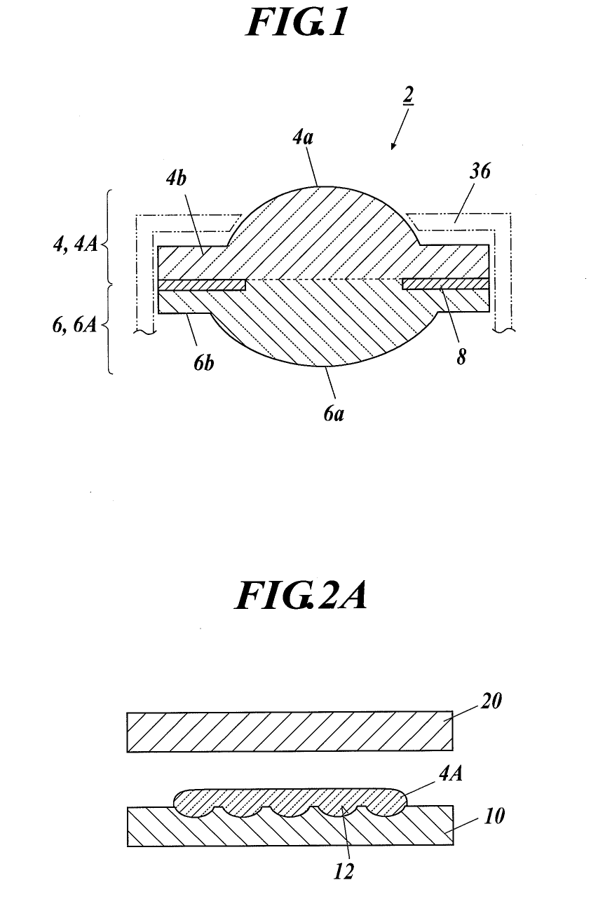

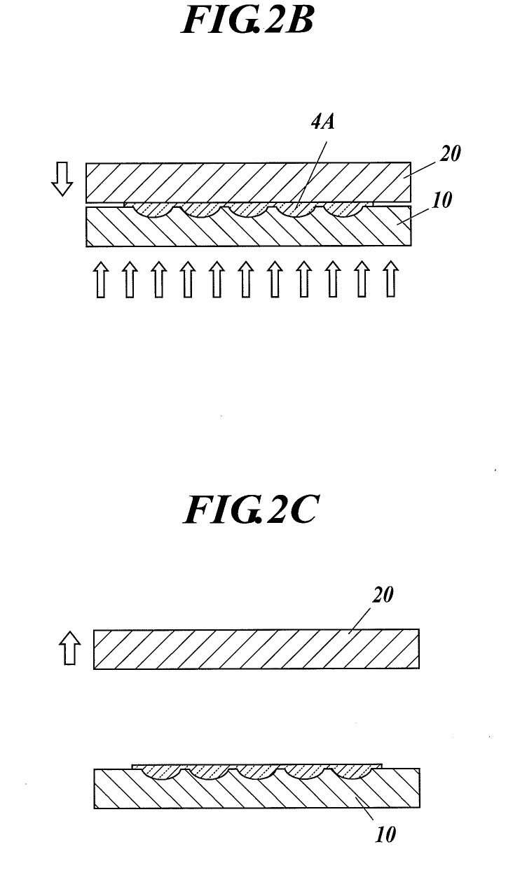

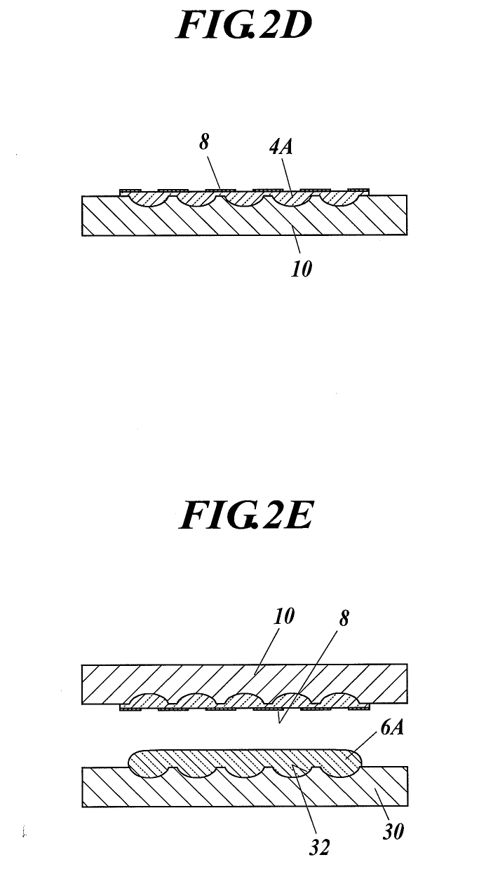

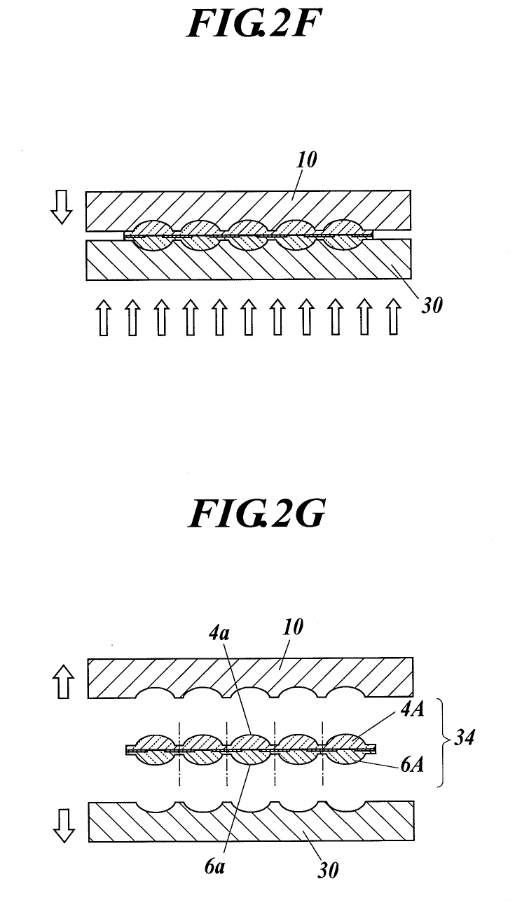

As shown in FIG. 2A, a lens array mold 10 is coated with a resin 4A. The lens array mold 10 has an array of multiple recess portions 12. The shape of each recess portion 12 corresponds to the shape of the convex lens portion 4a of the imaging lens 2.

Then, as shown in FIG. 2B, one of the lens array mold 10 and a plate member 20 is moved toward the other such that the space between the lens array mold 10 and the plate member 20 is filled with the resin 4A, and the resin 4A is cured by light or heat.

Then, as shown in FIG. 2C, the plate member 20 is removed.

Then, as shown in FIG. 2D, the diaphragm 8 is formed on the cured resin 4A.

The diaphragm 8 may be formed with a photoresist including black pigments through photolithography or with a metal film such as a chromium film through etching. An inkjet or screen printing process can also be applied to form the diaphragm 8. Alternatively, a dimensionally stable black diaphragm member with a similar shape to the lens array, having a light-transmission hole at a region corresponding to the convex lens portion 4a, can be sandwiched between the resins 4A and 6A to form a diaphragm 8. This prevents a change in distances between the convex lens portions 4a and 6a after demolding.

Then, as shown in FIG. 2E, a lens array mold 30 is coated with the resin 6A. The lens array mold 30 has an array of multiple recess portions 32. The shape of each recess portion 32 corresponds to the shape of the convex lens portion 6a of the imaging lens 2.

Then, as shown in FIG. 2F, while the cured resin 4A and the diaphragm 8 are left on the lens array mold 10, one of the lens array mold 30 and 10 is moved onto the other such that the space between the lens array molds 30 and 10 is filled with the resin 6A, and then the resin 6A is cured by light or heat.

Preferably, the lens array molds 10 and 30 are provided with alignment marks preliminarily formed, so that alignment between these lens array molds 10 and 30 can be achieved through matching of the alignment marks. Alternatively, the lens array molds 10 and 30 are provided with alignment guides preliminarily formed, so that the alignment between the lens array molds 10 and 30 can be achieved by abutting the guides mutually.

Then, as shown in FIG. 2G, the lens array molds 10 and 30 are detached from the cured resins 4A and 6A to give a lens array 34 composed of the resins 4A and 6A. The lens array 34 including convex lens portions 4a and 6a is cut into multiple imaging lenses 2. Alternatively, the lens array 34 can also be delivered from the factory as it is.

According to the above embodiment, from the curing step of the resin 4A on the lens array mold 10 (see FIG. 2B) to the removal step of the lens array molds 10 and 30 (see FIG. 2G), the process is carried out with the cured resin 4A remaining on the lens array mold 10. This keeps the cured resin 4A fixed to the recess portions 12 and thus can prevent a change in distance between convex lens portions 4a caused by the resin 4A at least during those steps.

Moreover, the resin components 4 and 6 are composed of the resins 4A and 6A, respectively, which are different resins. The combination of different resins can achieve higher optical performance and more flexible designing compared to a case of manufacturing an imaging lens with a single resin material.

In addition, the curing of the resin 4A with the plate member 20 enables the corresponding face of the cured resin 4A to be planarized, thus facilitating the formation of the diaphragm 8 inside the imaging lens 2. Such a process does not require a diaphragm structure 36 such as a housing having an opening corresponding to the convex lens portion 4a (see FIG. 1) over the exterior of an imaging lens 2, and alignment between the imaging lens 2 and the diaphragm 36 or an aperture position. This can improve handling performance or versatility of the imaging lens 2.

Here, the convex lens portion 4a of the resin component 4 and the convex lens portion 6a of the resin component 6 may have any profile and can be produced with appropriate lens array molds 10 and 30 having corresponding profiles.

### Second Embodiment

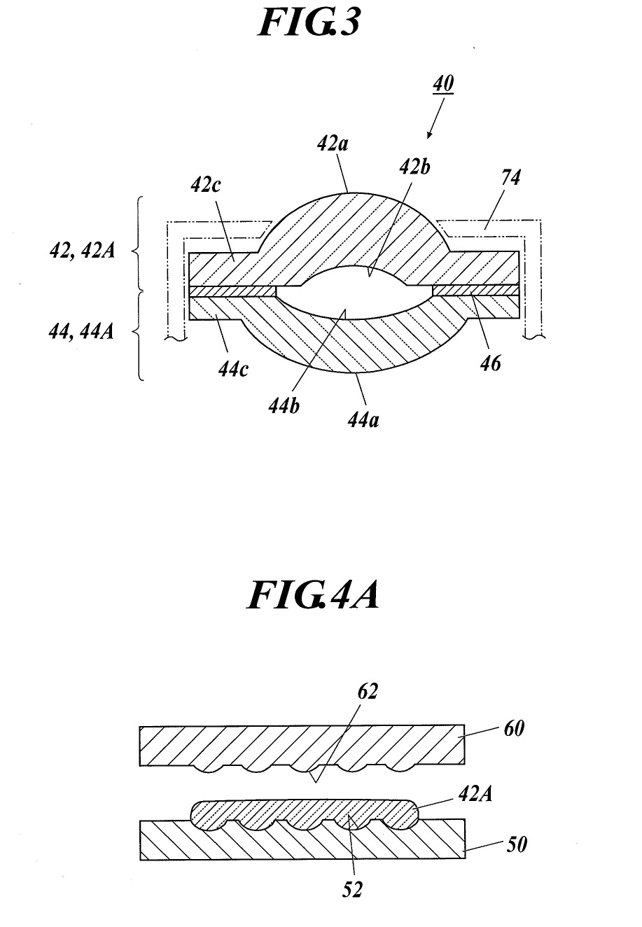

As shown in FIG. 3, a stacked imaging lens 40 is a combination lens including two lenses, namely a lens 42 and a lens 44.

The lens 42 has a convex lens portion 42a and a concave lens portion 42b. The convex lens portion 42a and the concave lens portion 42b are surrounded by a non-lens portion 42c or flange.

The lens 44 also has a convex lens portion 44a and a concave lens portion 44b. The convex lens portion 44a and the concave lens portion 44b are surrounded by a non-lens portion 44c or flange.

The convex lens portion 42a and the concave lens portion 42b of the lens 42 and the convex lens portion 44a and the concave lens portion 44b of the lens 44 are all arranged in corresponding positions. The concave lens portion 42b of the lens 42 faces the concave lens portion 44b of the lens 44. The centers of the convex lens portion 42a, the concave lens portion 42b, the convex lens portion 44a, and the concave lens portion 44b are aligned to a common optical axis. A diaphragm 46 is provided between the non-lens portions 42c and 44b of the lens 42 and 44, respectively. Instead of such a configuration, the convex lens portion 42a may be a concave lens portion, the concave lens portion 42b may be a convex lens portion, the convex lens portion 44a may be a concave lens portion, and/or the concave lens portion 44b may be a convex lens portion.

The lens 42 is composed of a resin 42A, and the lens 44 is composed of a resin 44A.

The resin 42A and 44A are photocurable or thermally curable resins.

The resin 42A and 44A are composed of different materials with different optical dispersions (Abbe's numbers), and in particular one of the resins 42A and 44A is composed of a low dispersion material and the other a high dispersion material.

In the case of the stacked imaging lens 40, which is a combination lens, and has an air layer between the lens 42 and 44, the resin 42A and 44A may have the same refractive index.

The resin 42A and 46A may be the same resin.

Next, a method of manufacturing the stacked imaging lens 40 will now be described.

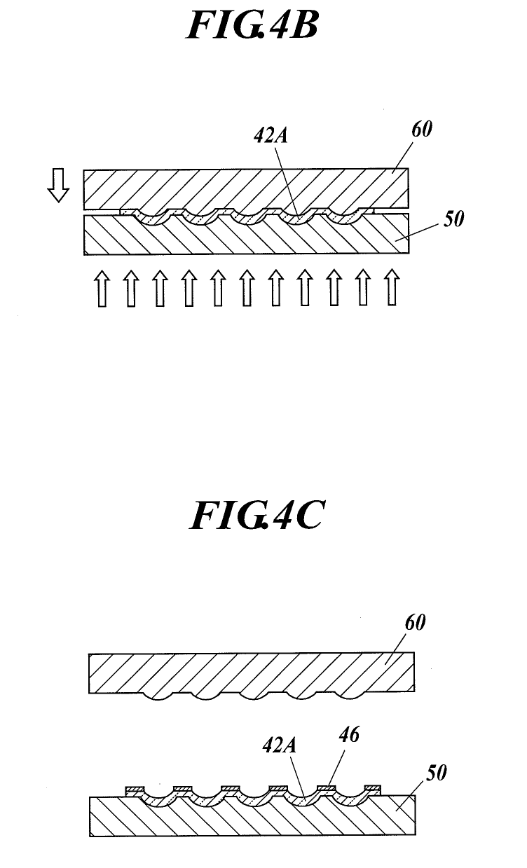

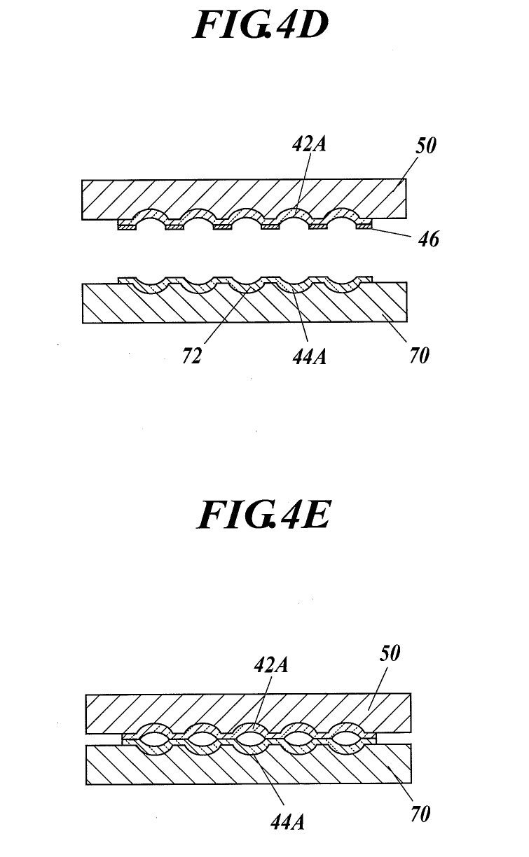

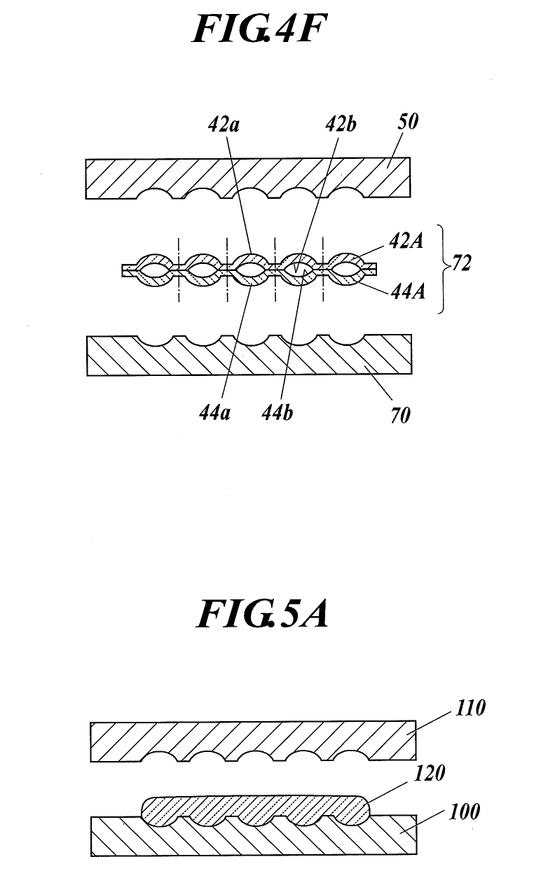

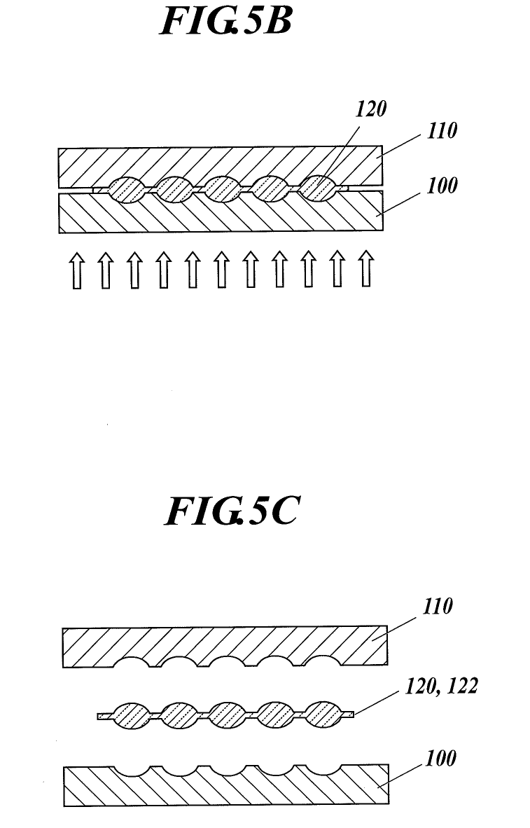

As shown in FIG. 4A, the lens array mold 50 is coated with the resin 42A. The lens array mold 50 has an array of multiple recess portions 52. The shape of each recess portion 52 corresponds to the shape of the convex lens portion 42a of the lens 42.

Then, as shown in FIG. 4B, one of the lens array molds 50 and 60 is moved onto the other such that the space between the lens array molds 50 and 60 is filled with the resin 42A, and the resin is cured by light or heat. The lens array mold 60 has an array of multiple projection portions 62. The shape of each projection portion 62 corresponds to the shape of a concave lens portion 42b of the lens 42.

Preferably, the lens array molds 50 and 60 are provided with alignment marks preliminarily formed, so that the lens array molds 50 and 60 are aligned with each other by matching the alignment marks.

Then, as shown in FIG. 4C, the lens array mold 60 is removed.

A diaphragm 46 is then formed on the cured resin 42A.

The diaphragm 46 can be formed by the same process for the diaphragm 8 in the first embodiment. The diaphragm 46 may extend over a part of the concave lens portion 42b. A surface covered by the diaphragm 46 is curved in this case, then the diaphragm 46 is preferably formed by an inkjet printing technique.

In this case, at least an area of the lens array mold 60 corresponding to the area covered by the diaphragm 46 is preferably planar. This has an advantage in that the planar surface can allow for use of patterning techniques, such as photolithography and screen printing, which are rather inappropriate to delineate high precision patterns on a curved surface.

As shown in FIG. 4D, a cured resin 44A on a lens array mold 70 is formed aside from the cured resin 42A by a similar process shown in FIG. 4A through 4C.

Then, as shown in FIG. 4E, while the cured resin 42A and the diaphragm 46 remain on the lens array mold 50 and the cured resin 44A remains on the lens array mold 70, one of the lens array molds 50 and 70 is moved onto the other to bond the cured resin 42A, the diaphragm 46, and the cured resin 44A.

The lens array molds 50 and 70 are preferably provided with alignment marks preliminarily formed, then the lens array molds 50 and 70 are aligned with each other through matching the alignment marks, and are mutually bonded with an adhesive or any other means.

Then, as shown in FIG. 4F, the lens array molds 50 and 70 are detached from the cured resins 42A and 44A to give a stacked lens array 72 including the cured resins 42A and 44A. The stacked lens array 72 including the convex lens portions 42a (or the concave lens portion 42b, or the convex lens portions 44a, or the concave lens portion 44b) is cut into multiple stacked imaging lenses 40. Alternatively, the lens array 72 can also be delivered from the factory as it is.

According to the above embodiment, from the step of curing the resin 42A in the lens array mold 50 and curing the resin 44A in the lens array mold 70 (see FIG.4B and 4D) through the step of removing the lens array molds 50 and 70 (see FIG. 4F), the process is carried out with the cured resins 42A and 44A remaining on the lens array molds 50 and 70, respectively. Accordingly, the cured resins 42A and 44A are maintained in the recess portions 52 and 72, respectively, at least during those process steps. This enables variations in distances to be reduced between the convex lens portions 42a and between the convex lens portions 44a caused by the resins 42A and 44A.

Moreover, the lenses 42 and 44 are formed with different resins 42A and 44A. The combination of different resins can achieve higher optical performance and more flexible designing of the lens compared to a case of manufacturing a stacked imaging lens with a single resin material.

In addition, the cured resin 42A is bonded with the cured resin 44A after the diaphragm 46 is formed on the cured resin 42A. This indicates that the diaphragm 46 is formed inside the stacked imaging lens 40. This does not require a diaphragm structure 74 such as a housing having an opening corresponding to the convex lens portion 42a (see FIG. 3) over the exterior of a stacked imaging lens 40, and alignment between the stacked imaging lens 40 and the diaphragm 74 or an aperture position. This can improve handling performance or versatility of the stacked imaging lens 40.

Here, the convex lens portion 42a and the concave lens portion 42b of the lens 42 and the convex lens portion 44a and the concave lens portion 44b of the lens 44 may have any profile and can be produced with appropriate lens array molds 50, 60, and 70 having corresponding profiles.

### INDUSTRIAL APPLICABILITY

The present invention can be suitably applied to an imaging lens and an image capturing device including such an imaging lens.

### LIST OF REFERENCE NUMERALS

2 imaging lens

4 resin component

4A resin

4a convex lens portion

4b non-lens portion (flange)

6 resin component

6A resin

6a convex lens portion

6bnon-lens portion (flange)

8 diaphragm

10 lens array mold

12 recess portion

20 plate

30 lens array mold

32 recess portion

34 lens array

36 diaphragm

40 stacked imaging lens

42 lens

42A resin

42a convex lens portion

42b concave lens portion

42c non-lens portion (flange)

44 lens

44A resin

44a convex lens portion

44b concave lens portion

44c non-lens portion (flange)

46 diaphragm

50 lens array mold

52 recess portion

60 lens array mold

62 projection portion

70 lens array mold

72 stacked lens array

74 diaphragm

100, 110 array mold

120 curable resin

122 lens array

1. A method of manufacturing a lens array comprising the steps of:
feeding a first curable resin between a first array mold and a plate member and curing the first resin;
separating the plate member from the first array mold;
feeding a second curable resin between the first array mold and a second array mold while leaving the cured first resin on the first array mold, and curing the second resin; and
removing the first array mold and the second array mold.

2. The method of manufacturing a lens array according to claim 1, further comprising the step of forming a diaphragm on the cured first resin remaining on the first array mold after separating the plate member and before feeding the second curable resin, and curing the second resin.

3. The method of manufacturing a lens array according to claim 1, wherein the first curable resin and the second curable resin are resins of different kinds.

4. The method of manufacturing a lens array according to claim 1, wherein the first curable resin and the second curable resin are resins of the same kind.

5. A method of manufacturing a stacked lens array comprising the steps of:
feeding a first curable resin between a first array mold and a second array mold, and curing the first resin;
removing the second array mold;
feeding a second curable resin between a third array mold and a fourth array mold, and curing the second resin;
removing the fourth array mold;
bonding the cured first resin remaining on the first array mold and the cured second resin remaining on the third array mold; and
removing the first array mold and the third array mold.

6. The method of manufacturing a stacked lens array according to claim 5, further comprising the step of forming a diaphragm on the cured first resin remaining on the first array mold after removing the second array mold.

7. The method of manufacturing a stacked lens array according to claim 6, wherein at least an area of the second array mold corresponding to the area covered by the diaphragm on the cured first resin is planar.

8. The method of manufacturing a stacked lens array according to claim 5, wherein the first curable resin and the second curable resin are resins of different kinds.

9. The method of manufacturing a stacked lens array according to claim 5, wherein the first curable resin and the second curable resin are resins of the same kind.

10. The method of manufacturing a stacked lens array according to claim 5, wherein the second array mold and the fourth array mold are configured so that the cured first resin and the cured second resin bonded one another have lens portions each having a space between the cured first and second resins.

11. The method of manufacturing a stacked lens array according to claim 10, wherein at least one of the lens portion on the cured first resin facing to the cured second resin and the lens portion on the cured second resin facing to the cured first resin is a concave lens.

12. A method of manufacturing a plurality of lenses, comprising the step of cutting the lens array obtained by the method according to claim 1.

13. A method of manufacturing a plurality of stacked lenses, comprising the step of cutting the lens array obtained by the method according to claim 5.

14. The method of manufacturing a lens array according to claim 2, wherein the diaphragm is made of a photoresist including black pigments.

15. The method of manufacturing a lens array according to claim 2, wherein the diaphragm is made of a metal.

16. The method of manufacturing a lens array according to claim 6, wherein the diaphragm is made of a photoresist including black pigments.

17. The method of manufacturing a lens array according to claim 6, wherein the diaphragm is made of a metal.

18. A method of manufacturing a lens array, comprising:
curing a first curable resin with the first resin intervening between a first array mold and an opposite member thereof;
removing the opposite member with the cured first resin remaining on the first array mold;
disposing a diaphragm on the cured first resin remaining on the first array mold;
curing a second curable resin with the second resin intervening between the cured first resin on which the diaphragm is disposed and a second array mold; and
removing the first array mold and the second array mold to thereby obtain the lens array.

19. A method of manufacturing a lens array according to claim 18, wherein the diaphragm is made of a photoresist including black pigments.

20. A method of manufacturing a stacked lens array, comprising:
curing a first curable resin with the first resin intervening between a first array mold and a second array mold;
removing the second array mold with the cured first resin remaining on the first array mold;
curing a second curable resin with the second resin intervening between a third array mold and a fourth array mold;
removing the fourth array mold with the cured second resin remaining on the third array mold;
disposing a diaphragm between the cured first resin remaining on the first array mold and the cured second resin remaining on the third array mold, and bonding the cured first resin and the cured second resin; and
removing the first array mold and the third array mold to thereby obtain the stacked lens array.

21. A method of manufacturing a lens array according to claim 20, wherein the diaphragm is made of a photoresist including black pigments.
